(19) United States
(12) Patent Application Publication
(10) Pub. No.: US 2009/0259945 A1
(43) Pub. Date: Oct. 15, 2009

(54) SYSTEM AND METHOD FOR GENERATING WEB BASED MULTI-TIER, WIKI-BASED CONTROL PANELS

(75) Inventor: Kristof De Spiegeleer, Knokke-Heist (BE)

Correspondence Address: DLA Piper LLP (US) / Sun Microsystems, Inc., 2000 University Avenue, East Palo Alto, CA, 94303, US

(73) Assignee: Qlayer NV, Lochristi (BE)

(21) Appl. No.: 12/421,355

(22) Filed: Apr. 9, 2009

Related U.S. Application Data
(60) Provisional application No. 61/043,754, filed on Apr. 10, 2008.

(51) Int. Cl. G06F 3/048; G06F 15/16

(52) U.S. Cl. 715/744

(57) ABSTRACT

A system and method for generating web based multi-tier, wiki-based control panels that provides a technique for provisioning and managing datacenter services, such as for example physical and virtual servers.

### PRIORITY CLAIM/RELATED APPLICATIONS

This application claims the benefit under 35 USC 119(e) and priority under 35 USC 120 to U.S. Provisional Patent Application Ser. No. 61/043,754, filed on Apr. 10, 2008 and entitled “Multi tier wiki based control panels for virtual infrastructure” which is incorporated herein by reference.

### FIELD

The disclosure relates to a system and method for provisioning and managing datacenter services and in particular to a system and method for generating web based, multi-tier, wiki-based control panels for provisioning and managing datacenter services.

### BACKGROUND

Datacenters are well known and are used to host network infrastructure such as servers, switches, storage devices etc. Commercial datacenters are operated by a service provider and the service provider may offer rack space (so called server collocation) and also provide managed hosted services. In the latter case, the service provider manages one or more servers for a customer.

Depending on the business of the service provider, the customer may need the ability to remotely manage the servers, to get remote access to the servers or to see various reports of the servers (e.g. reports on uptime, resource usage, backups, security etc.). In order for the service provider to provide customers with certain forms of remote self-service management, web based control panels may be used.

To provide the customers with the remote self-service management, the customer will typically login using a secure web application after which certain control panels are available in the browser of the customer allowing the customer to see and/or manage certain aspects of the datacenter infrastructure of the customer located in the datacenter of the service provider.

The control panels in these typical systems are implemented as a web application/pages 20 as shown in FIG. 1, with a dynamic scripting languages such as for example PHP Hypertext Preprocessor (PHP) script which is a well known scripting language originally designed for producing dynamic web pages so that the PHP script is executed each time that a user accesses the web page. Each user 21, 22, 23 access the same web page. Thus, these current remote self-service management control panels have some important limitations. In particular, current control panels are not easily customizable on a per customer basis which means that if the service provider wants to/needs to customize certain features of the control panels, these changes are available to all customers, not just one customer.

In addition, current control panels are hard to extend which is a major limitation taking into account that service providers may want to provide new services to customers. It is desirable however, to provide control panels that are extensible to allow certain forms of remote management of other datacenter services, such as for example virtual servers, storage capacity, virtual appliances, CPU capacity, network capacity, software applications, Software as a Service, security appliances, load balancing appliances etc. In addition, the desirable extensible control panels allow an IT department, which may operate as a service provider in an enterprise, to use web based control panels to provide remote access to business units within the enterprise. Thus, it is desirable to provide a system and method for generating web based multi-tier, wiki-based control panels that provides extensible and user customizable control panels and it is to this end that the disclosure is directed.

### BRIEF DESCRIPTION OF THE DRAWINGS

FIG. 1 illustrates a typical way to implement control panels;

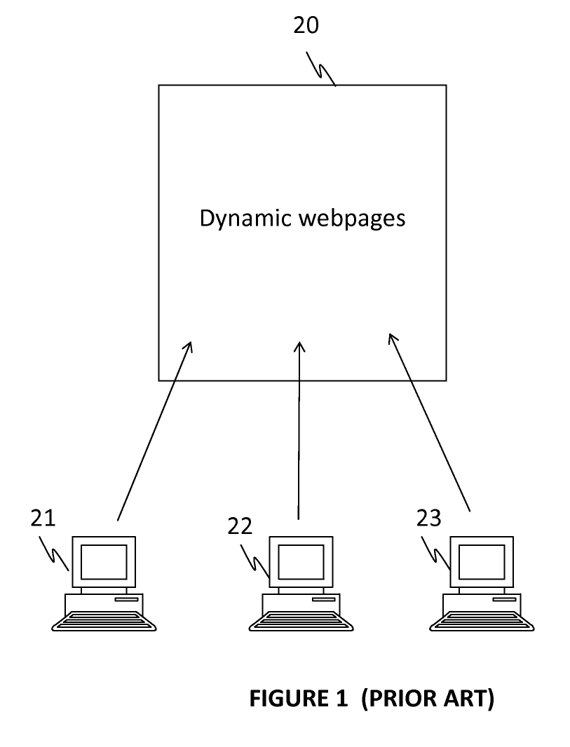

FIG. 2 illustrates an example of a multi-tier wiki that may be used with the wiki based control panel system shown in FIG. 3; and

FIG. 3 is an implementation of a wiki based control panel system.

### DETAILED DESCRIPTION OF ONE OR MORE EMBODIMENTS

The disclosure is particularly applicable to a system and method for generating web based multi-tier, wiki-based control panels for a virtual environment to provide a technique for provisioning and managing datacenter services, such as for example physical and virtual servers and it is in this context that the disclosure will be described. It will be appreciated, however, that the system and method has greater utility since it can be used for generating web based multi-tier, wiki-based control panels for various other purposes and is not limited to the technique for provisioning and managing datacenter services, such as for example physical and virtual servers. Before describing an implementation of wiki based control panel system, a multi-tiered wiki space is described that can be used with the wiki based control panel system. A space is a set of wiki pages to which a user has access.

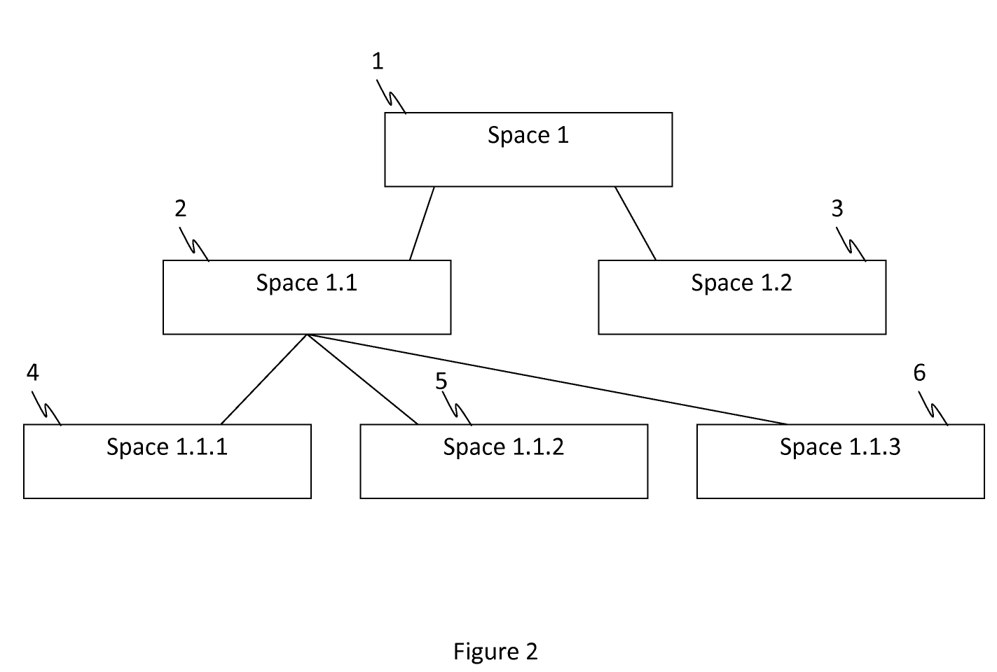

FIG. 2 is a schematic representation of multi-tiered wiki space 10. The multi-tier wiki space may have a space 1 [1] that has two subspaces 1.1 [2] and 1.2 [3] and subspace 1.1 has three subspaces 1.1.1 [4], 1.1.2 [5] and 1.1.3 [6]. The multi-tier wiki space shown in FIG. 2 may be used by the wiki based control panel system to provide a control panel for each device, such as one or more devices in a datacenter including physical servers, virtual servers, virtual appliances and physical appliances. In particular, each user has permission rights to certain wiki pages that provide control panels for the particular user.

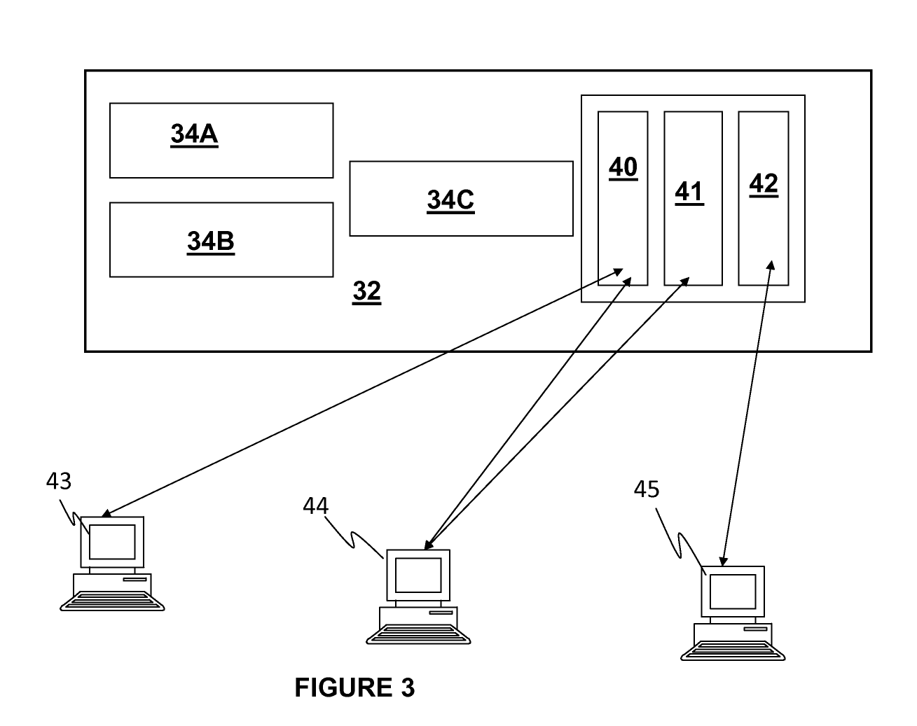

FIG. 3 is an implementation of a wiki based control panel system 30 that provides control panels, such as for selection of devices in a datacenter to communicate with, using a wiki. The system 30, in this implementation, is implemented within a datacenter 32 that houses one or more devices 34 (such as devices 34a, 34b and 34c in the example shown in FIG. 3). Each device may be a physical server computer, a virtual server computer, a physical appliance or a virtual appliance.

Typically, the devices in the datacenter are owned/leased by different entities (people, corporations, companies, etc.) and each entity would like to have access to manage their devices or execute applications resident on their devices. The system 30, when implemented in a datacenter, further comprises a multi-tier wiki portal 36 (that may be an existing wiki portal or a proprietary wiki portal that may or may not be housed in the datacenter) that stores one or more sets of wiki pages wherein each set of wiki pages (which may be one or more wiki pages) has a set of permissions that allow certain entities to access each wiki page wherein each wiki page is a control panel that is unique for the entities that have access to that wiki page as described below in more detail. In the example shown in FIG. 3, a first entity 43 and a second entity 44 have permissions to access a first set of wiki pages 40, the second entity has permissions to access a second set of wiki pages 41 and a third entity 45 has permissions to access a third set of wiki pages 42.

Based on the information/instructions/data in the set of wiki pages to which the entity has access, one or more control panels specific to the entity can be generated wherein the control panels provide remote management capabilities for datacenter services/devices. The datacenter services include but are not limited to dedicated servers, virtual servers, virtual private datacenter (VPDC) environments, CPU capacity of a device in the datacenter, a private network (a LAN or VLAN), network capacity of a device in the datacenter, storage capacity of a device in the datacenter, virtual appliances, software applications, “Datacenter as a Service” services etc.

In one implementation, the control panels are implemented as a web based application, running on one or more physical or virtual servers. In one implementation, for each entity, one space in the wiki portal 36 is generated that has one or more Wiki web pages. The entity may be a customer of the datacenter and may be a company, a reseller, an individual, a group of individuals, a manager, etc. In the system, each entity receives credentials that give access to the space of that entity.

As shown above in FIG. 2, the control panels in one implementation are implemented as a multi-tier wiki which means that a space may contain other spaces (sub spaces) as shown in FIG. 2. When the space for an entity has sub-spaces, the entity not only has access to his own space but also to the sub spaces. The multi-tier wiki concept facilitates various use cases, for example, resellers of service providers that manage multiple customers, managers that manage spaces of multiple employees, etc. The multi-tier concept implies that spaces are organized in a tree hierarchy where one or more root spaces exist, and underneath each root space zero or more other spaces may exist. This tree hierarchy is unlimited in depth (spaces may contain other spaces and this applies on all levels of the hierarchy). A particular entity may or may not be able to create a new sub-customer and hence an entity may or may not be able to create sub-spaces from within his own space.

The generation of a space comprises creation of web pages (wiki pages) on a server and the creation is based on templates. Each web page of the space is generated based on a template. A template defines the look and feel of a webpage, the default content and other settings. Because each space is generated and present on a server as a specific set of web pages in the wiki portal, it is possible to make changes to said web pages for a first entity, without affecting the spaces of other entities as long as those other entities do not have permission to access to the space of the first entity.

Within the web pages of a space, one or more web controls may be integrated wherein a web control provides a set of management capabilities for a specific datacenter service. A web control may be integrated in a Wiki web page by using a macro or plug-in or placeholder concept as provided by the Wiki portal used to implement the control panels. The reference in the Wiki page to the web control may be using a URL or any other form of reference wherein the reference may include a unique identifier to a specific datacenter service. In one embodiment, a globally unique identifier (GUID) is used to uniquely identify a datacenter service which is managed by said web control. The GUID is a very long unique identifier which cannot be “guessed” and thus provides a secure means of referencing a datacenter service. During the generation of the space of a customer, the web controls are placed on the web pages of the space, by placing the correct code in each Wiki page, including the correct references.

Examples of web controls include:
A web control to list physical servers or other assets of one customer
A web control to manage physical or virtual server or a virtual appliance
A web control to manage a file server
A web control to manage storage capacity
A web control to visualize reports

A web control may be implemented as a server side web application and/or using client side web based technologies such as for example (but not limited to) HTML, Javascript, DHTML, Flash.

In one implementation, an existing wiki portal system is used, such as for example, Trac, xWiki, Mediawiki or any other Wiki system. The Wiki portal system may be installed on a virtual server or physical server (such as shown in FIG. 3) and made accessible over the public internet using HTTP and/or HTTPS or be installed on a separate device outside of the datacenter and made accessible over the public internet using HTTP and/or HTTPS.

For each new customer of the datacenter that requires access to control panels, a customer account is created in the Wiki system, which allows the customer to log in to the Wiki system. In one implementation, the datacenter system has a manager unit (that may be hardware or software or a combination thereof) that sets-up the account in the wiki so that the customer will be granted access to a personal set of pages, called a “space”. The customer creation is executed by calling the appropriate method from the API of the Wiki system. In cases in which no APIs are available, the customer is created by inserting a record in the Wiki database or by adding an entry in the appropriate configuration file of the Wiki system. For each datacenter service to which the customer requires access, at least one page is automatically generated, within the space of the customer. This Wiki page is accessible by the customer once it has been automatically generated. For example, in case the customer has permissions to access a set of 5 servers in the datacenter, at least 5 Wiki pages will be generated.

The Wiki pages for the customer may be generated by calling the appropriate method from the API of the Wiki system. In case no API is available, the Wiki page is created by inserting a record in the Wiki database or by adding an entry in the appropriate configuration file of the Wiki system or by creating a file on disk. The static content of each generated Wiki page is retrieved from a database such as a known configuration management database (CMDB) or any other database, which contains detailed information on the datacenter service which is exposed. The dynamic content is displayed on the Wiki page by integrating a web control on the Wiki page. The web control is a web based control, created for example using a web scripting language (e.g. Java, PHP . . . ). The web control can be integrated into the Wiki page by means of a placeholder, a frame or by any other means supported by the Wiki system.

As an example, a Wiki page with detailed technical information on a physical or virtual server in a datacenter, may have, for example, following content:
Static content:
   Name of server: e.g. “Server 123”
   IP address of server and other network configuration
   Firewall configuration
   Logging information
   System administration information which is specific to this server (e.g. manually entered notes)
Dynamic content:
   Web control to allow remote administration of the server:
      Reboot
      Start/stop
      Remote access (Telnet, SSH, KVM . . . )

At the time that the Wiki page is generated, the information is retrieved from one or more databases (e.g. CMDB databases in the datacenter).

The Web control is referenced by using a URL, with a unique identifier to the server for which the Wiki page provides information. For Example:
/webcontrols/remoteServerManagement.php?server_id=123

The unique identifier may be an id, a GUID or any other type of reference. The web control uses this unique identifier to look up additional information in a database or to interact with various datacenter services (e.g. a powerswitch to reboot the server).

While the foregoing has been with reference to a particular embodiment of the invention, it will be appreciated by those skilled in the art that changes in this embodiment may be made without departing from the principles and spirit of the invention, the scope of which is defined by the appended claims.

1. A method to generate control panels to provide access to datacenter services, the method comprising:
creating, on a computer, two or more wiki spaces for two or more entities of a datacenter in a wiki portal where each entity has access privileges only to the space assigned to that entity, wherein each wiki space further comprises one or more wiki pages;
creating, in the wiki portal for each customer, a wiki page that is part of the space for each datacenter service to which the entity has access; and
wherein each wiki page is a control panel for administration by the entity of a first datacenter service using the wiki page created for that first datacenter service.

2. The method of claim 1, wherein each entity is an entity that manages a plurality of datacenter customers and wherein each wiki space further comprises one or more subspaces wherein each subspace is assigned to a customer of the datacenter assigned to the entity that manages a plurality of datacenter customers wherein the customer has access privileges to the subspace assigned to the customer and wherein the entity that manages a plurality of datacenter customers has access privileges to all of the subspaces of the space of the entity that manages a plurality of datacenter customers.

3. The method of claim 1, wherein each entity is a customer of the datacenter.

4. The method of claim 1, wherein generating the control panel further comprises creating a wiki page for each control panel wherein each wiki page contains static content and zero or more web controls that render dynamic content integrated into the wiki page.

5. The method of claim 4, wherein the web control further comprises an identifier to a datacenter service.

6. The method of claim 5, wherein the identifier is a globally unique identifier.

7. The method of claim 1, wherein the datacenter service further comprises one of a physical server, a virtual server, a virtual datacenter environment, a CPU capacity measurement of a device in the datacenter, a private network, a network capacity measurement of a device in the datacenter, a storage capacity measurement of a device in the datacenter, a virtual appliance and a software application.

8. A system for generating control panels to provide access to datacenter services, comprising:
a datacenter having one or more devices wherein the datacenter provides one or more datacenter services, the datacenter having a manager unit that manages a wiki portal associated with the datacenter;
the wiki portal associated with the datacenter having two or more wiki spaces for two or more entities of a datacenter in the wiki portal where each entity has access privileges only to the space assigned to that entity, wherein each wiki space further comprises one or more wiki pages wherein a wiki page, that is part of the space for a entity, is created for each datacenter service to which the entity has access; and
where each wiki page is a control panel for administration by the entity of a first datacenter service, using the wiki page created for that first datacenter service.

9. The system of claim 8, wherein the wiki portal is housed within the datacenter.

10. The system of claim 8, wherein each entity is an entity that manages a plurality of datacenter customers and wherein each wiki space further comprises one or more subspaces wherein each subspace is assigned to a customer of the datacenter assigned to the entity that manages a plurality of datacenter customers wherein the customer has access privileges to the subspace assigned to the customer and wherein the entity that manages a plurality of datacenter customers has access privileges to all of the subspaces of the space of the entity that manages a plurality of datacenter customers.

11. The system of claim 8, wherein each entity is a customer of the datacenter.

12. The system of claim 8, wherein the wiki page is a control panel wherein each wiki page contains static content and zero or more web controls that render dynamic content integrated into the wiki page.

13. The system of claim 12, wherein the web control further comprises an identifier to a datacenter service.

14. The system of claim 13, wherein the identifier is a globally unique identifier.

15. The system of claim 8, wherein the datacenter service further comprises one of a physical server, a virtual server, a virtual datacenter environment, a CPU capacity measurement of a device in the datacenter, a private network, a network capacity measurement of a device in the datacenter, a storage capacity measurement of a device in the datacenter, a virtual appliance and a software application.
